(19) United States
(12) Patent Application Publication
(10) Pub. No.: US 2026/0151851 A1
(43) Pub. Date: Jun. 4, 2026

(54) A TABLE AND A MARKING SYSTEM

(71) Applicant: Maxce Australia Pty Ltd, Wantirna South VIC (AU)

(72) Inventor: Benjamin Evan MAXWELL, Wantirna South VIC (AU)

(21) Appl. No.: 19/122,062

(22) PCT Filed: Oct. 18, 2023
(86) PCT No.: PCT/AU2023/051034

§ 371 Date: Apr. 17, 2025

(30) Foreign Application Priority Data
Oct. 18, 2022 (AU) 2022903059

(51) Int. Cl. B23K 26/08; B23K 26/364

(52) U.S. Cl. CPC B23K 26/0853; B23K 26/364

(57) ABSTRACT

A table that includes a base, a tabletop and an operationally-coupled motor system. The tabletop of the table is movably mounted on the base of the table. The motor system of the table is operationally coupled to the tabletop for actuating movement thereof relative to the base of the table.

### PRIORITY CLAIM

The present application is a National Phase entry of PCT Application No. PCT/AU 2023/051034, filed Oct. 18, 2023, which claims the benefit of Australian Patent Application No. 2022903059, filed Oct. 18, 2022, which are incorporated herein by reference in their entirety.

### TECHNICAL FIELD

The disclosure herein generally relates to a table, and a marking system comprising the table.

### BACKGROUND OF THE INVENTION

Laser marking has become increasingly popular. Laser marking may be used to, for example, make durable, fine and precise marks at high speed. During laser marking, a laser beam is used to mark a wide range of materials, examples of which include but are not limited to ceramics, glass, woods, plastics, metals, foils and laminates. A movable mirror, for example, may be used to direct the laser beam. Examples of laser markings include but are not limited to a person's name engraved on a ring, and a part identification number written onto a manufactured part. The interaction between the laser beam and the material depends on the material-example interactions include but are not limited to engraving the material, removing a layer of material, staining the material, annealing the material, foaming the material, and carbonising the material.

It may be desirable to improve the laser marking process and laser marking apparatus.

It may be similarly desirable to improve other marking processes and systems, examples of which include but not limited to pad printing and UV printing.

### SUMMARY OF THE INVENTION

Disclosed herein is a table. The table comprises a base. The table comprises a tabletop movably mounted on the base. The table comprises a motor system operationally coupled to the tabletop for actuating movement thereof relative to the base.

In an embodiment, the motor system comprises at least one of a drive belt and a drive chain operationally coupled to the tabletop. At least one of the drive belt and the drive chain may be ended. At least one of the drive belt and the drive chain may be attached to the tabletop. A drive pulley may be engaged with the drive belt.

An embodiment comprises a toothed drive belt.

An embodiment comprises at least one idler pulley engaged with the drive belt.

In an embodiment, the motor system comprises a motor. The motor may be mounted to the base. The motor may be at least in part within the base. The motor may comprise a stationary motor stator.

An embodiment may comprise a motor driver for driving the motor.

An embodiment may comprise at least one bearing supporting the tabletop. The at least one bearing may be attached to at least one of the base and the tabletop. The tabletop may comprise at least one guide supported by the at least one bearing. The at least one guide may be captured by the at least one bearing. The at least one guide may comprise at least one linear rail.

The tabletop comprises at least one stiffening member longitudinally aligned to the tabletop, which may comprise the at least one guide.

An embodiment comprises:
at least one linear bearing attached to the base and a marking area delimited by the at least one linear bearing; and
at least one tabletop stiffening linear guide attached to the tabletop, wherein the at least one tabletop stiffening linear guide is supported by the at least one linear bearing. The tabletop stiffening guide may be captured by the at least one linear bearing. The at least one tabletop stiffening guide may comprise at least one tabletop stiffening linear rail.

In an embodiment, the motor is located within the range of motion of the tabletop.

In an embodiment, the motor system is operationally coupled to the tabletop for actuating linear movement thereof relative to the base.

An embodiment of the table may be for a marking system, for example a laser marking system.

Disclosed herein is a marking system comprising the table in accordance with the above disclosure.

An embodiment comprises a laser system configured to generate a laser beam and arranged to direct the laser beam at the tabletop. The laser system may be arranged to direct the laser beam at a laser marking area of the tabletop intermediate the base and laser system. The laser marking area may be a minority of a face of the tabletop.

An embodiment comprises a processor configured to coordinate operation of the laser and the tabletop.

Any of the various features of each of the above disclosures, and of the various features of the embodiments described below, can be combined as suitable and desired.

### BRIEF DESCRIPTION OF THE DRAWINGS

Embodiments will now be described by way of example only with reference to the accompanying figures in which:

FIG. 1 shows a top perspective view of an embodiment of a table, in which a tabletop is visible.

FIG. 2 shows a top view of the table of FIG. 1.

FIG. 3 shows a front elevation view of the table of FIG. 1.

FIG. 4 shows a rear elevation view of the table of FIG. 1.

FIG. 5 shows a bottom view of the table of FIG. 1.

FIG. 6 shows an elevational view of a side of the table of FIG. 1.

FIG. 7 shows an elevational view of another side of the table of FIG. 1.

FIG. 8 shows a top perspective view of the table of FIG. 1, with a tabletop thereof hidden to reveal a motor system.

FIG. 9 shows a perspective view of the underside of the tabletop, with some parts removed.

FIG. 10 shows a perspective view of the underside of the tabletop with a plate removed. FIG. 11 shows a perspective view of part of the tabletop translation system.

FIG. 12 shows another perspective view of part of the tabletop translation system.

FIG. 13 shows a rear elevation view of the part of the tabletop translation system.

FIG. 14 shows a front elevation view of the part of the tabletop translation system.

FIGS. 15-19 show various perspective views of drive belt attachment and limit switch activators.

FIG. 20 shows a schematic diagram of an embodiment of a laser marking system.

### DETAILED DESCRIPTION OF THE DRAWINGS

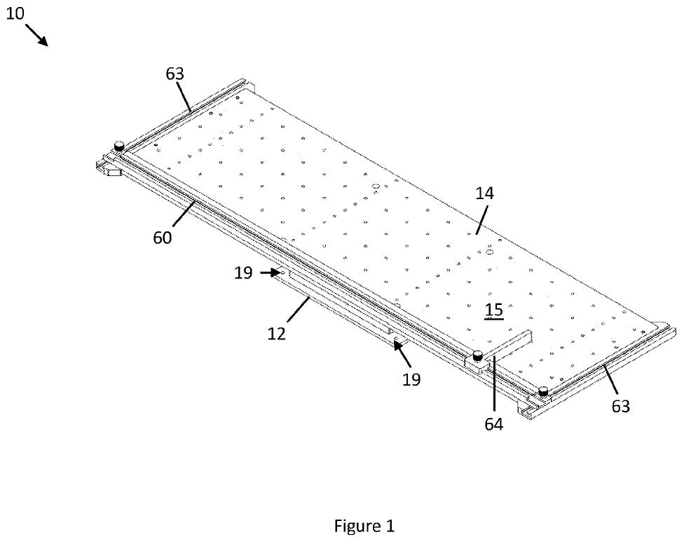

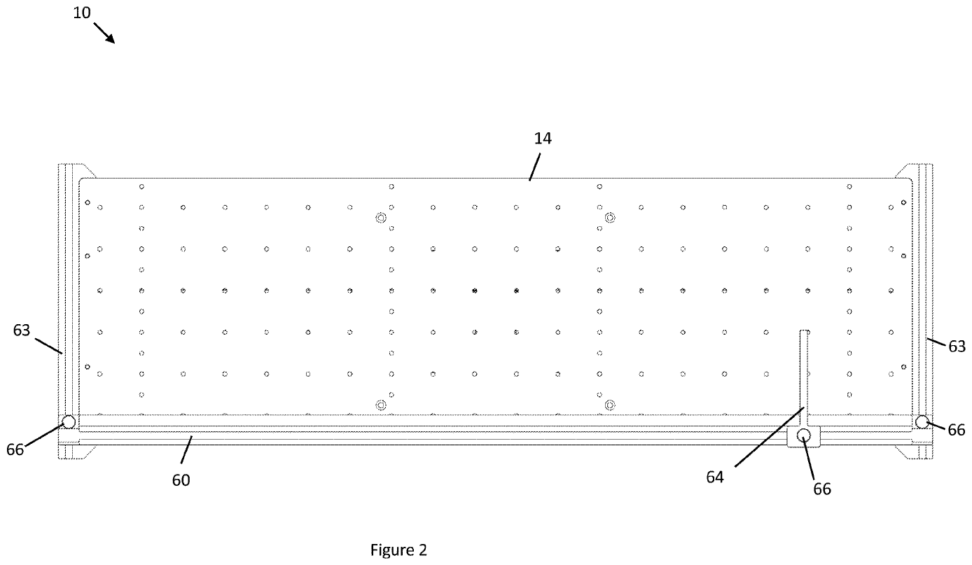

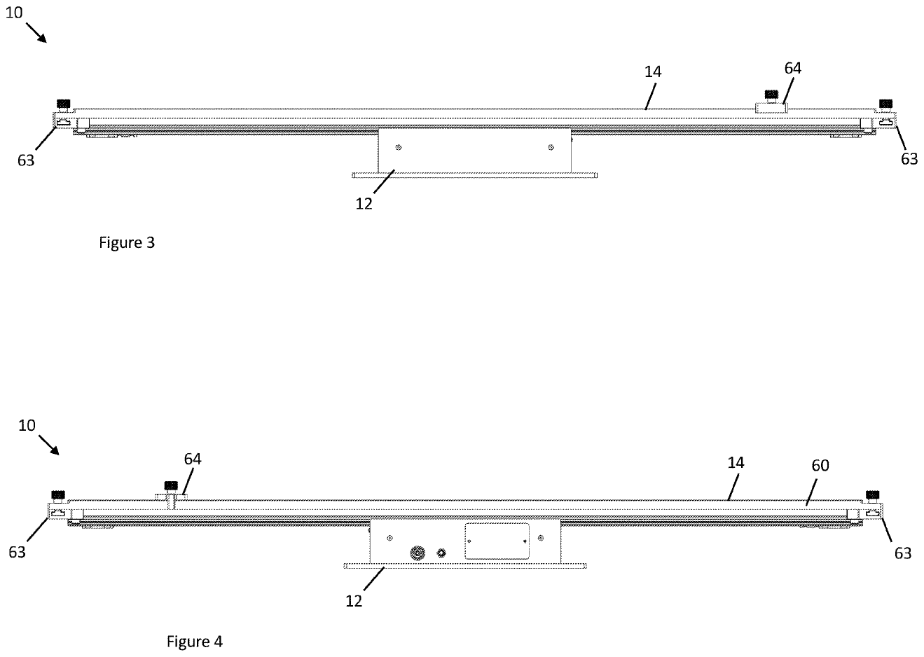

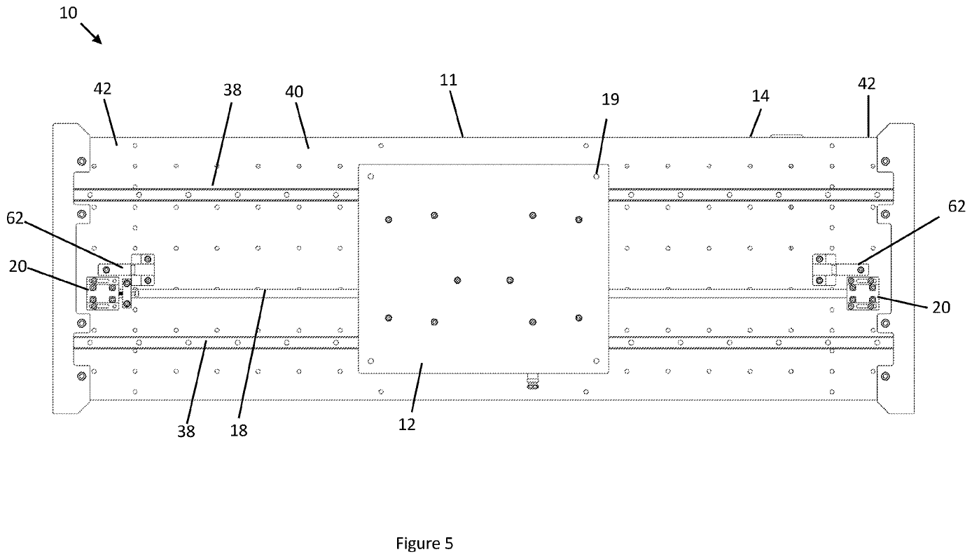

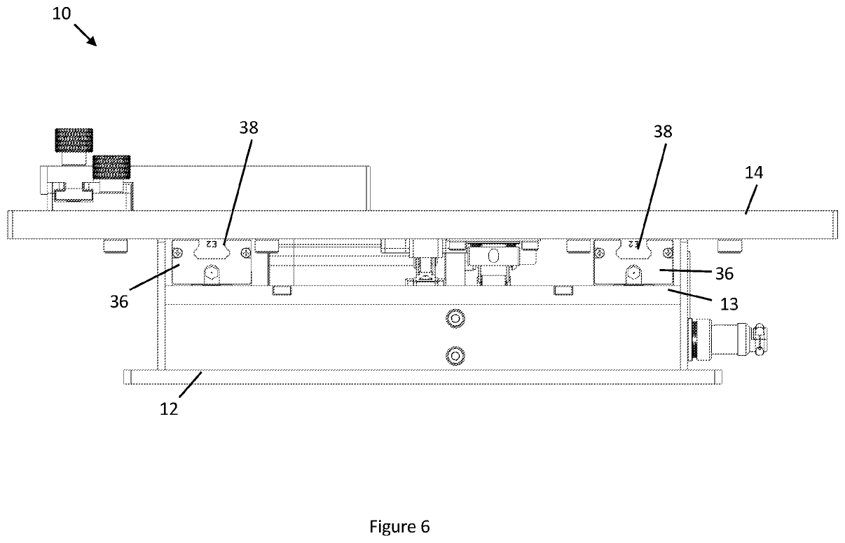

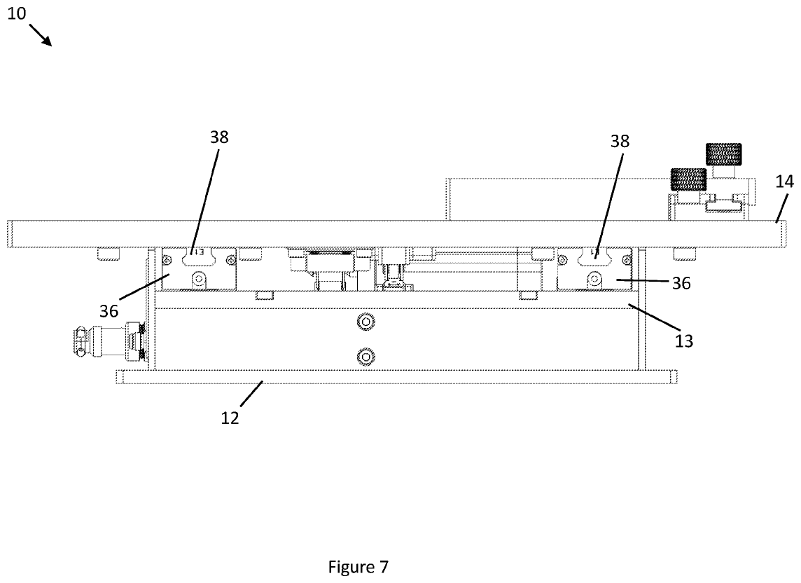

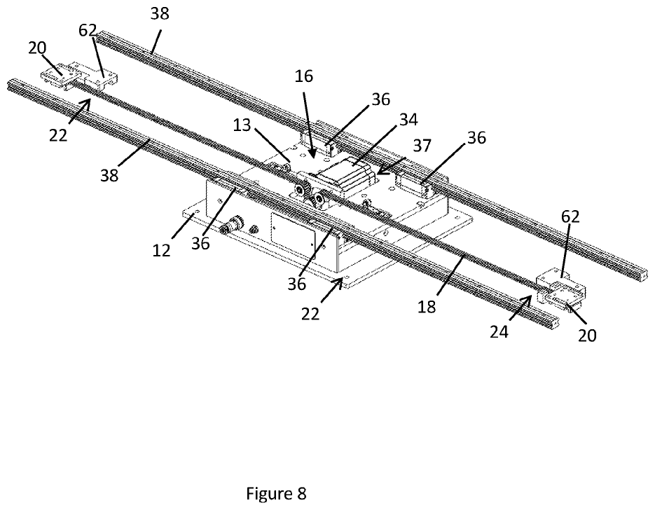

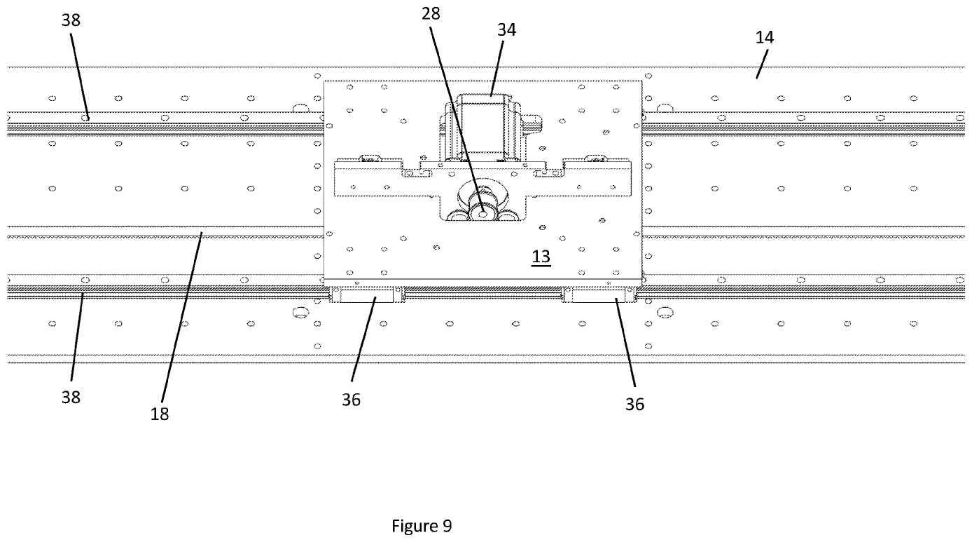

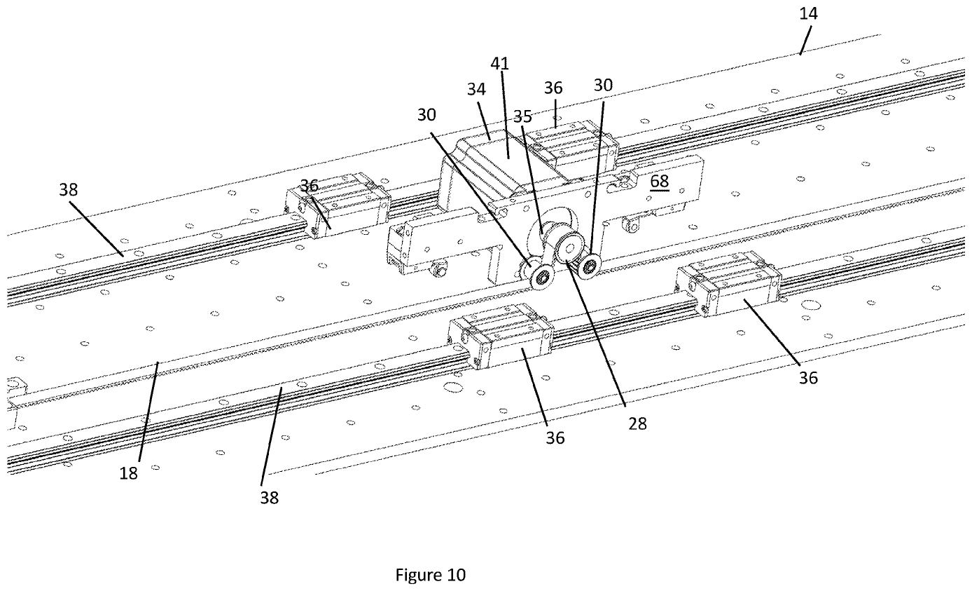

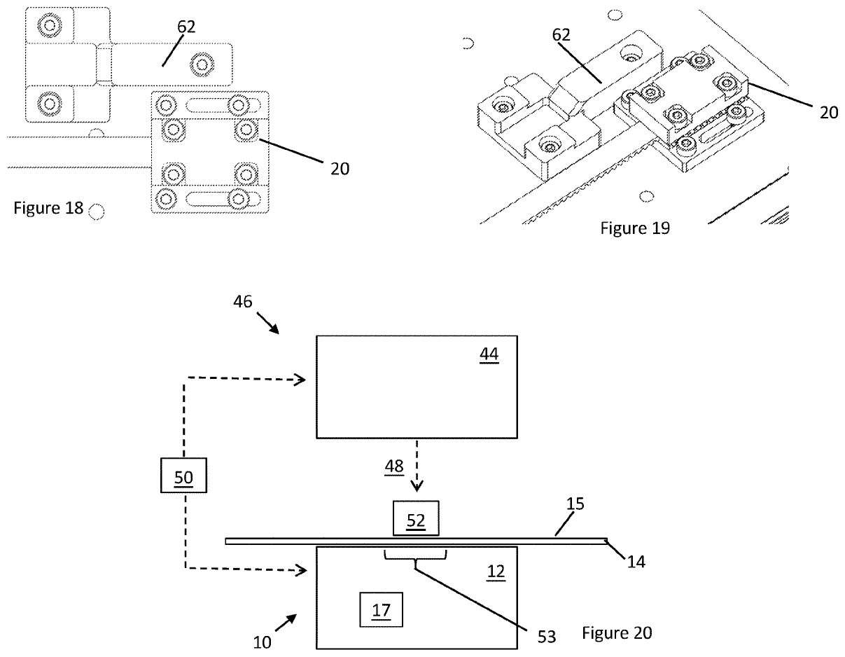

The FIGS. 1 to 19 show various views and aspects of an embodiment of a table, the table being generally indicated by the numeral 10. The table 10 is for a laser marking system, however the present and/or alternative embodiments may be used for other applications including other marking systems including but not limited to printing, pad printing and UV printing. The table comprises a base 12. The table comprises a tabletop 14. The tabletop 14 is for receiving on an upward surface 15 thereof at least one object to be marked with a laser or otherwise. The tabletop 14 is movably mounted on the base 12. The table 10 comprises a motor system generally indicated by numeral 16 in FIG. 8 and operationally coupled to the tabletop 14 for actuating movement thereof relative to the base 12.

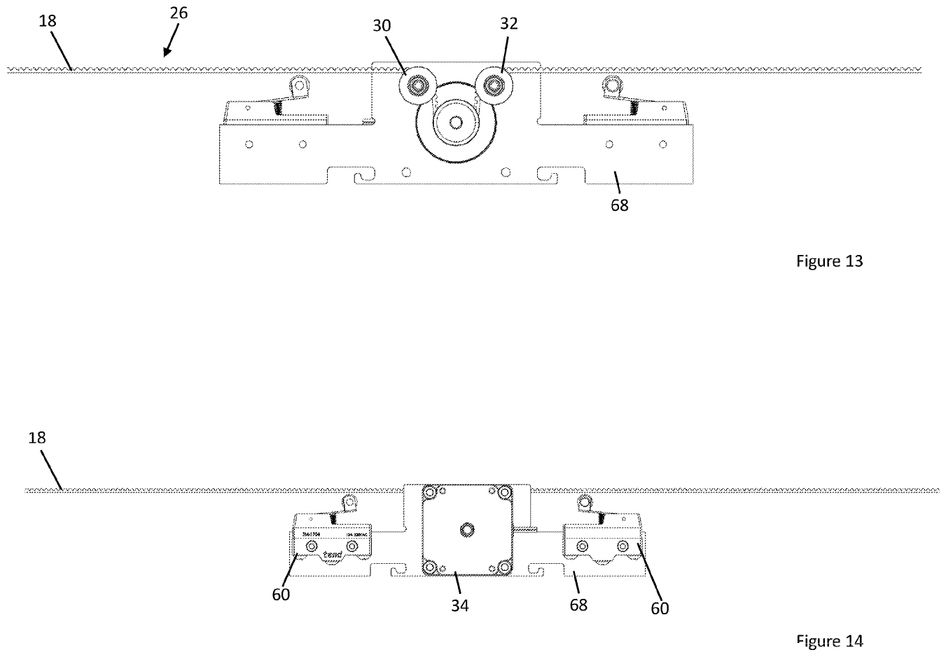

The motor system 16 comprises a drive 18 in the form of a drive belt that is operationally coupled to the tabletop 14. The belt has two ends, and is not looped, and so can be characterised as an ended belt. The table 10 comprises a plurality of drive belt attachments 20 in the form of drive belt clamps that attach the drive belt 18—by clamping—to a plate 11 of the tabletop 24. The plurality of drive belt attachments 20 are attached to the plate 11 by mechanical fasteners in the form of screws and/or bolts. One of the plurality of drive belt attachments 20 is attached to an end 22 of the drive belt 18 and another one of the plurality of drive belt attachments 20 is attached to another end 24 of the drive belt 18. The drive belt 18 optionally comprises a plurality of teeth 26, as seen in FIG. 13, for example. The motor system 16 comprises a drive pulley 28 engaged with the drive belt 18. The motor system 16 optionally comprises at least one optional idler pulley 30,32 mounted on an idler shaft and engaged with the drive belt 18. In this embodiment idler pulleys 30,32 are on opposite sides of the drive pulley 28 and in the same plane as the drive pulley 28, however they may generally have any useable and desired arrangement. The at least one idler pulley 30 is arranged to wrap the drive belt 18 around the drive pulley 28, which may reduce slippage between the drive belt 18 and the drive pulley 28. The motor system 16 comprises an electric motor 34 in the form of a stepper motor that is configured to electrically couple to a motor driver in the form of a stepper motor driver generally but not necessarily installed in a laser controller. In alternative embodiments, the table 10 may comprise the motor driver, however the motor driver may yet still be separate from the table 10 and the laser controller. The motor 34 is mounted to the base 12 via mounting plate 68. The motor 34 is operationally coupled to drive pulley 28. The drive pulley 28 is mounted to a rotor 35 of the motor 34. The rotary motion of the motor rotor 35 is converted into a linear movement of the drive belt 18 and so the tabletop 14 attached thereto. The rotor 35 can rotate both clockwise and anticlockwise to move the tabletop 14 in opposite linear directions. During operation of the motor 34—during which the rotor 35 rotates—a motor stator 41 is not translated (“stationary motor stator”), however the tabletop 14 is translated relative to base 12 and the motor 34. The table 10 can be configured so that the tabletop 14, base 12 and motor 34 are centred, as shown in FIGS. 1, 9 and 10 for example. The base 12 in use is supported by a surface in the form of, for example, a table top surface or bench top surface. The base 12 may be adapted to be attached to the surface. The base is generally stationary during translation of the tabletop.

The motor system 16 is generally mounted within a cavity 37 defined by the base 12. At least one motor cables and/or wire and at least one switch cable and/or wire are generally disposed in the base 12. The at least one cable and/or wire is disposed in the base 12, being internally connected to plug and/or socket connectors at the rear of the base 12. External cables for the motor 34 and switches can be connected between the base 12 and the laser controller. The motor 34 is located inside the range of motion of the tabletop.

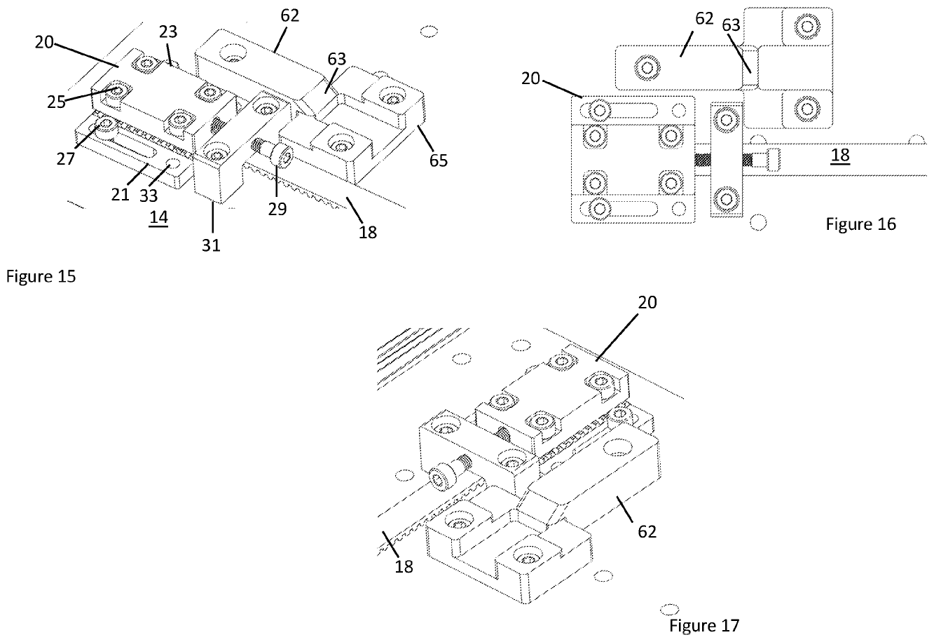

As shown in FIG. 15, each of the drive belt attachments 20 have opposite clamp members 21,23 in between which a respective end of the drive belt 18 is secured by clamping. The drive belt attachment 20 comprises at least one clamping screw 25 operable to close the space between the opposite clamp members 21,23 to clamp. One of the clamping members 21 is slidably attached to the tabletop 14 by a plurality of attachments screws 27 passing through a plurality of longitudinally orientated slots. A fixed position bolt hole 33 is also provided. The plurality of attachment screws 27 can be loosened for adjusting the position of the opposite clamp members 21,23. This can be used to tension the drive belt 18. One of the drive belt attachments 20 shown in FIG. 15, for example, comprises a belt tension adjustment screw 29 that is longitudinally orientated and which engages at least one of the opposite clamp members 21,23—in this but not all embodiments the clamp member 23. The tabletop 14 comprises a threaded screw mount 31 to which the tension adjustment screw 29 is threadingly engaged. The tension adjustment screw 29 is operable to move the drive belt attachment 20 and so tension the drive belt 18 when the plurality of attachment screws 27 are loosened. The screws 27 can be tightened when the desired drive belt tension is achieved.

As shown in FIG. 8, the table 10 comprises at least one bearing 36—in this embodiment four bearings—in the form of linear bearing carriages (or alternatively low friction pads or generally any suitable and desired form) supporting the tabletop 14 and attached to the base 12 by mechanical fasteners, and so fixed to the base. The tabletop 14 comprises at least one guide 38 in the form of at least one rail attached to the top plate 11 by mechanical fasteners-and so the rail is fixed to the tabletop 11—in the form of screws and/or bolts—in this embodiment two linear rails—at an underside 40 of the tabletop 14 and slidably supported by the at least one bearing 36. The at least one rail 38 is captured by the at least one bearing 36. The at least one rail 38 is elongated and longitudinally aligned to the tabletop. The at least one bearing 36 is attached to a bearing mount plate 13 at the top of the base 12. The motor system 16 is coupled to the tabletop 14 by drive belt 18.

The bearing mount plate 13 provides structural reinforcement near the bearings 36. The at least one rail 38 act as optional stiffening members to stiffen the elongated table which is only supported in the vicinity of the base 12 and so generally reduces sagging of the cantilevered portions 42 of the tabletop 14. The length of the base 12 is in the present embodiment less than 30% the length of the table, which provides for travel of the tabletop 14. Other embodiments may have other base lengths as suitable and desired.

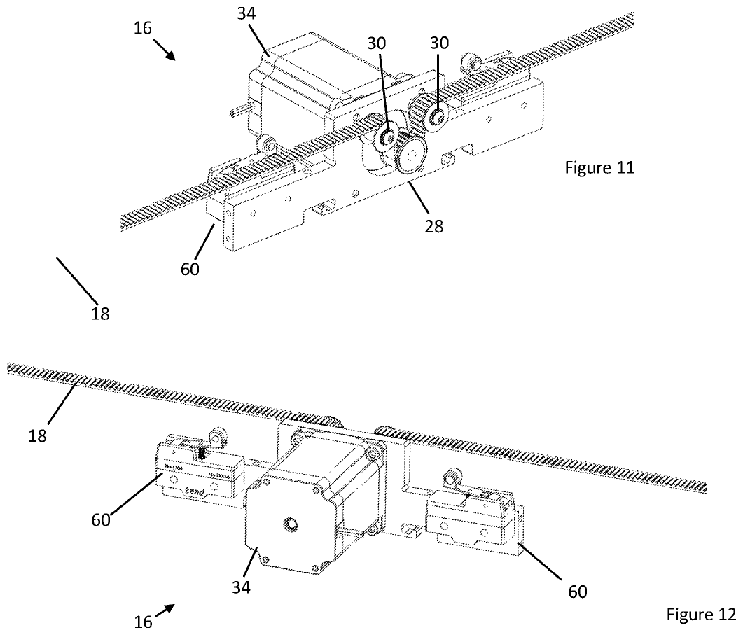

As seen in FIGS. 11 and 12, for example, mounted to each side of the motor 34 are proximity sensors 60 in the form of tabletop position sensors. The tabletop position sensors are in the form of contact switches, specifically roller switches. The tabletop 14 comprises a plurality of sensor engagers 62 comprising a plurality of tabs 63 and a plurality of stops 65 adjacent opposite ends of the tabletop 14, and which are cooperatively arranged with the tabletop position sensors 60 to engage the sensors 60 to generate a signal that a tab 63 is at a respective position sensor 60, and a limit of the table's movement has been reached. A proximity sensor signal is sent to the laser marking controller. The laser marking controller uses the proximity sensor signal for position referencing and limiting the travel movement of the tabletop 14 prior to the hard-stops 65. They can also be used as limit stops to prevent overrun and stop the table prior to the hard-stops making contact. The hard stops 65 are arranged to contact the motor mount plate 68 and stop the movement of the tabletop 14. The hard stops 65 are a fail-safe, to prevent the bearings 36 running off the rails 38, or the belt clamps 20 impacting the pulleys 30,32 in the event the switch fails.

The laser marking controller provides positioning control signals to a stepper motor driver and monitoring of the table position sensors. An alternative controller may provide positioning control and proximity sensor monitoring. An alternative controller may be independent of a laser controller. Alternative controllers may receive instructional signals from, but not exclusively, a laser controller which then generates a positional operation. Other instructional signals may be in the form of at least one discrete electrical signal, wired digital communication, or wireless commands.

Mounted to the upward surface 15 of the tabletop 14 is an optional fence system. An alternative embodiment does not comprise a fence system. The fence system comprises a longitudinally orientated guide 60 in the form of a rail slidably mounted to laterally orientated guide 63 attached to opposite longitudinal ends of the tabletop 14. Perpendicularly and slidably mounted to guide rail 60 is at least one square 64, however an alternative embodiment does not comprise the at least one square. Fasteners in the form of screw fasteners 66 can releasably fix the position of the rail 60 and square 64.

FIG. 20 shows a schematic diagram of an embodiment of a marking system 46 in the form of a laser marking system. The laser marking system 46 comprising the table 10. The laser marking system 46 comprises a laser system 44 configured to generate a laser beam 48 and arranged to direct the laser beam 48 at the tabletop 14. The laser system 44 is optionally arranged to direct the laser beam 44 at a laser marking area 53 intermediate the base 12 and laser system 44. The laser marking area 53 is a minority of the face 15 of the tabletop. The laser marking area 53 is optionally fixed with respect to the base 12, however not the tabletop 14 which can translate relative to the base 12 and laser system 44. Translation of the tabletop enables the laser system 44 to address with the laser beam 48 at least a majority of the tabletop surface 15 that is orientated towards the laser system 44. The laser marking area is in this but not necessarily all embodiments delimited by the plurality of bearings 37.

In the present but not necessarily all embodiments, the laser marking system 46 comprises a processor 50 in signal communication with the motor driver 17. The processor 50 is configured to send command signals to the motor driver to drive the stepper motor—and consequently the movement of the tabletop 14—and is also in signal communication with the laser 44 to control the operation thereof. The processor 50 is configured to coordinate operation of the laser 48 and movement of the tabletop 12 to effect marking of the object 52 on the tabletop 12. Alternative laser controllers with alternative electrical interfaces may be used. This may—but not necessarily—require changing the motor driver 17 (e.g. one configured for ethernet or fieldbus, rather than hardwired pulse signals). The processor 50 is in the form of a general purpose computer, however may generally take any suitable form example of which include a system on a chip, a system on a board and an embedded system.

The embodiment of a table 10 can be an accessory to an existing laser or other marking system that is operable without the table 10. Table 10 may expand the capabilities of the existing marking system. The table 10 defines mounting holes 19 through the base for fastening the base to, for example, a bench. Alternative embodiments may be integral to a marking system.

The table 10 optionally has a mass of no more than 16 kg. The tabletop optionally has a mass of no more than 7 kg. Consequently, the table 10 can be lifted and subsequently moved by an individual person. The tabletop 14 and the base 12 comprises metal in the form of, for example, an aluminium alloy, suitable examples of which include but are not limited to 5083 aluminium alloy and 6061 aluminium alloy. The tabletop 14 and base 12 are non-flammable against the laser beam. The tabletop 14 increases the operational work area of the laser marking machine to up to, for example, 1000 mm×300 mm or more.

Other embodiments of the marking system comprise a printing system, for example a pad printing system or a UV printing system.

Now that embodiments have been described, it will be appreciated that some embodiments have some of the following advantages:
The bearings may remain static relative to the laser. Consequently, the distance from the laser head to the marking surface may be consistent for when the tabletop moves. Any bow or deflection across the length of the top plate may be corrected relative to the laser as it moves through the bearings. Without this advantage, there may be sagging across the plate length and deflection at the far ends, resulting in inconsistent focus height and inconsistent laser marking along the length.
There may be no compounded angular position error relative to the laser as the tabletop moves from one side to the other.
Table height variations below the laser marking head may be minimised as the tabletop remains captured by the bearings within the laser marking area, generally above the base, for the full movement of the tabletop.
The guides may stiffen the tabletop, allowing the use of a thinner and lighter tabletop without the tabletop sagging or bowing.
Embodiments may have relatively low mechanism mass for manual lifting.
Embodiments may have bolt-on mounting for quick attachment and detachment to a laser system.
Plugged electrical connections may allow quick connection and reconnection.
The motor may be protected within the base.
The motor may be centrally mounted in the base, which may provide at least some protection and/or stability.
Motor cables may not be exposed to the moving tabletop or external snags.
Drive belt arrangement may that make it less likely to cause injury or damage.
No moving cables may be required.
The motor size and drive pulley gearing may limit force to minimise the risk of injury due to crushing or pinching.
A plurality of objects to be laser marked may be disposed on the tabletop, increasing the operating period of the laser making system and freeing up a user to do other things for longer periods of time.
Longer objects may be marked.

Variations and/or modifications may be made to the embodiments described without departing from the spirit or ambit of the invention. For example:
The drive belt may be attached to the table with generally any suitable fastener including but not limited to a bolt.
The drive belt may be without teeth and the pulleys may be without grooves for the teeth.
The drive belt may be in the form of a chain, in which case sprockets may be used instead of pulleys.
The drive belt may have ridges, spikes, teeth, tabs or other form of motor engagement to the drive mechanism.
Any suitable form of switches may be used, for example switches with a bump lever or button. Alternatively, electronic proximity sensing devices in the form of photoelectric, inductive, magnetic, or other forms may be used.
Generally, any suitable type of motor may be used, examples of which include but are not limited to brushed DC, brushless DC, and AC motors.
Generally, any suitable and desired form of mechanical fasteners may be used, for example screws, bolts, pins and clips. Adhesive may be used in place of mechanical fasteners as suitable and desired.
While embodiments have a rectangular tabletop, it will be appreciated that generally the tabletop may have any suitable shape, for example elliptical or square.
The at least one guide may generally have any suitable section profile, examples of which include but are not limited to square, rectangular, Vignoles, and round.
The at least one guide may be integral with the tabletop. Examples of integral guides include but are not limited to a raised rib and a groove.

The at least one bearing may be configured to engage at least one edge of the table, in which case the at least one rail may not be required.
The drive belt or chain may be a continuous loop, that is not ended.
Generally, but not necessarily, any suitable materials may be used, including composites, metals and alloys, polymers, and other rigid materials.
The stiffening members may be integral with the tabletop or separately formed, for example.

The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A table, the table comprising:
a base;
a tabletop translatably mounted on the base; and
a motor system operationally coupled to the tabletop for actuating translation thereof relative to the base, wherein the motor system comprises a motor mounted to the base and located within a range of translation of the tabletop.

2. The table defined by claim 1, wherein the motor system comprises at least one of a drive belt and a drive chain operationally coupled to the tabletop.

3. The table defined by claim 2, wherein the at least one of the drive belt and the drive chain is ended.

4. The table defined by claim 2, wherein the at least one of the drive belt and the drive chain is attached to the tabletop.

5. The table defined by claim 2, comprising a toothed drive belt.

6. The table defined claim 2, comprising a drive pulley engaged with the drive belt.

7. The table defined by claim 6, comprising at least one idler pulley engaged with the drive belt.

8. The table defined by claim 1, wherein the motor is at least in part within the base.

9. The table defined by claim 8, wherein the motor comprises a stationary motor stator.

10. The table defined by claim 8, comprising a motor driver for driving the motor.

11. The table defined by claim 1, comprising at least one bearing supporting the tabletop.

12. The table defined by claim 11, wherein the at least one bearing is attached to at least one of the base and the tabletop.

13. The table defined by claim 12, wherein the tabletop comprises at least one guide supported by the at least one bearing.

14. The table defined by claim 13, wherein the at least one guide is captured by the at least one bearing.

15. The table defined by claim 13, wherein the at least one guide comprises at least one linear rail.

16. The table defined by claim 1, wherein the tabletop comprises at least one stiffening member longitudinally aligned to the tabletop.

17. The table defined by claim 1, comprising:
at least one linear bearing attached to the base and a marking area delimited by the at least one linear bearing;
at least one tabletop stiffening linear guide attached to the tabletop, wherein the at least one tabletop stiffening linear guide is supported by the at least one linear bearing.

18. The table defined by claim 17, wherein the tabletop stiffening linear guide is captured by the at least one linear bearing.

19. The table defined by claim 17, wherein the at least one tabletop stiffening linear guide comprises at least one tabletop stiffening linear rail.

20. The table defined by claim 1 configured for use with a marking system.

21-26. (canceled)
